(19) United States
(12) Patent Application Publication
(10) Pub. No.: US 2018/0165745 A1
(43) Pub. Date: Jun. 14, 2018

(54) Intelligent Recommendation Method and System

(71) Applicant: Alibaba Group Holding Limited, Grand Cayman (KY)

(72) Inventor: Yadong Zhu, Hangzhou (CN)

(21) Appl. No.: 15/836,455

(22) Filed: Dec. 8, 2017

(30) Foreign Application Priority Data
Dec. 9, 2016 (CN) 201611130481.3

(51) Int. Cl. G06Q 30/06; G06F 15/18; H04L 29/08

(52) U.S. Cl. CPC G06Q 30/0631; H04L 67/306; H04L 67/22; G06F 15/18

(57) ABSTRACT

Ae system including a client terminal that stores operating behaviors of a user; and a recommendation server that obtain a plurality of operation behaviors of the user within a preset time interval, and further, with respect to a particular product category of a plurality of product categories, selects multiple key operation behaviors associated with the particular product category from the plurality of operation behaviors, the plurality of operation behaviors being associated with the plurality of product categories, the plurality of operation behaviors being associated with a plurality of pages, the plurality of pages including a plurality of key operation pages and a plurality of information pages, the multiple key operation behaviors being ranked based on a time sequence; and a data analysis server that performs learning processing on the multiple key operation behaviors by using a reinforcement learning method to obtain a product recommendation strategy for the user.

### CROSS REFERENCE TO RELATED PATENT APPLICATIONS

This application claims priority to Chinese Patent Application No. 201611130481.3, filed on 9 Dec. 2016, entitled “Intelligent Recommendation Method and System,” which is hereby incorporated by reference in their entirety.

### TECHNICAL FIELD

The present disclosure relates to the field of information technology, and, more particularly, to an intelligent recommendation method and system.

### BACKGROUND

In recent years, product recommendation technology has been widely used in various shopping applications (Apps). The product recommendation technology recommends valuable products to the user to achieve the purpose of guiding the user and to improve the shopping experience of the user.

Recommending the product in a page is an important component of many shopping Apps. Currently, the most commonly used method for recommending the product is to obtain the most commonly viewed product or most searched keyword within a period of time, searching a product that matches the product or keyword from a product database according to the product or the keyword, and recommending the matching product to the user.

However, the user often is unsure what to purchase. For example, a transaction process from the time that the user views the product A to the time that the user purchases the product A may last multiple days and have a long decision period. Meanwhile, during the decision period, the user may also experience decision periods for other products. Due to the diversity and uncertainty of the user's decision behavior, the recommend method of the conventional techniques cannot guide the user to purchase the product A, and cannot enhance the user's purpose of making the selection decision.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure. The present disclosure provides a method and device for multi-display interaction, which makes the interaction process more vivid and real, which improves the user engagement.

The present disclosure provides an intelligent recommendation method and system, which improve accuracy and recommendation efficiency of product recommendation.

An intelligent recommendation method and system provided in an example embodiment of the present disclosure is implemented as follows:

An intelligent recommendation system includes:

A client terminal stores the user's operating behavior;

A recommendation server obtains a plurality of operation behaviors of the user within a preset time interval, wherein the plurality of operation behaviors is associated with a plurality of product categories, and the plurality of operation behaviors are associated with a plurality of pages. The plurality of pages includes a plurality of key operation pages and a plurality of information pages. The recommendations server further selects, with respect to a particular product category from the plurality of product categories, a plurality of key operation behaviors from the plurality of operation behaviors. The plurality of key operation behaviors is ranked based on time sequence, and associated with the particular product category and the plurality of key operation pages.

The data analysis server performs learning processing on the key operation behavior by using a reinforcement learning method to obtain a product recommendation strategy for the user.

The present disclosure also provides an intelligent recommendation method including:

obtaining a plurality of operational behaviors of a user within a preset time interval, wherein the plurality of operational behaviors is associated with a plurality of product categories, and the plurality of operational behaviors are associated with a plurality of pages, the plurality of pages including a plurality of key operation page and a plurality of information pages;

selecting, with respect to a particular product category from the plurality of product categories, a plurality of key operation behaviors from the plurality of operation behaviors, wherein the plurality of key operation behaviors is ranked based on time sequence, and associated with the particular product category and the plurality of key operation pages; and

performing learning processing on the key operation behavior by using a reinforcement learning method to obtain a product recommendation strategy for the user.

The intelligent recommendation method and system provided by the present disclosure performs screening and denoising of a plurality of operation behaviors of the users in a preset time interval according to product categories and page features and other reference standards to generate a sequence of key operation behaviors based on time sequence. Since the sequence of key operation behaviors is based on a specific product category and a key operation page, the sequence of key operation behaviors more clearly expresses a preference and an intention of a user for a specific product category within a preset time interval. Therefore, reinforcement learning is applied to the key operation behavior sequence to learn more accurately the user preferences, intentions, and other information to improve the accuracy of product recommendation. In addition, the extraction and dimension reduction of multiple operational behaviors also further enhance the efficiency of learning.

### BRIEF DESCRIPTION OF THE DRAWINGS

To more clearly illustrate the technical solutions in the example embodiments of the present disclosure, the drawings for illustrating the example embodiments are briefly introduced as follows. It is apparent that the FIGS only describe some of the example embodiments of the present disclosure. One of ordinary skill in the art may obtain other figures according to the FIGS without using creative effort.

FIG. 1 illustrates a flowchart of example user behavior sequences before and after purchasing a product according to an example embodiment of the present disclosure;

FIG. 2 illustrates a diagram of an example intelligent recommendation system according to an example embodiment of the present disclosure;

FIG. 3 illustrates a diagram of Markov Decision Process (MDP) model according to an example embodiment of the present disclosure;

FIG. 4 illustrates a flowchart of an example method for intelligent recommendation according to an example embodiment of the present disclosure;

FIG. 5 illustrates a flowchart of an example method for obtaining multiple operation behaviors according to an example embodiment of the present disclosure;

FIG. 6 illustrates a flowchart of another example method for obtaining multiple operation behaviors according to an example embodiment of the present disclosure;

FIG. 7 illustrates a flowchart of an example user behavior sequences within a preset time interval according to an example embodiment of the present disclosure;

FIG. 8 illustrates a flowchart of an example method for filtering key operation behaviors according to an example embodiment of the present disclosure;

FIG. 9 illustrates a flowchart of another example method for filtering key operation behaviors according to an example embodiment of the present disclosure;

FIG. 10 illustrates a flowchart of another example method for filtering key operation behaviors according to an example embodiment of the present disclosure;

FIG. 11 illustrates a flowchart of key operation behaviors of a user according to an example embodiment of the present disclosure;

FIG. 12 illustrates a flowchart of an example method for reinforcement learning according to an example embodiment of the present disclosure;

### DETAILED DESCRIPTION

In conjunction with the following FIGS of the present disclosure, the technical solutions in the example embodiments of the present disclosure will be clearly and completely described. Apparently, the described example embodiments are merely some example embodiments of the present disclosure and do not constitute limitation to the present disclosure. All other example embodiments obtained by those of ordinary skill in the art based on the example embodiments of the present disclosure fall within the scope of protection of the present disclosure. Any other example embodiment obtained one of ordinary skill in the art without creative efforts based on the example embodiments of the present disclosure shall belong to the protection scope of the present disclosure.

To help one of ordinary skill in the art understand the technical solutions of the present disclosure, the technical environment implemented by the technical solution is described below.

The meaning of product recommendation technology is that the products recommended to the user guide the user and help the user to make a decision on product purchase.

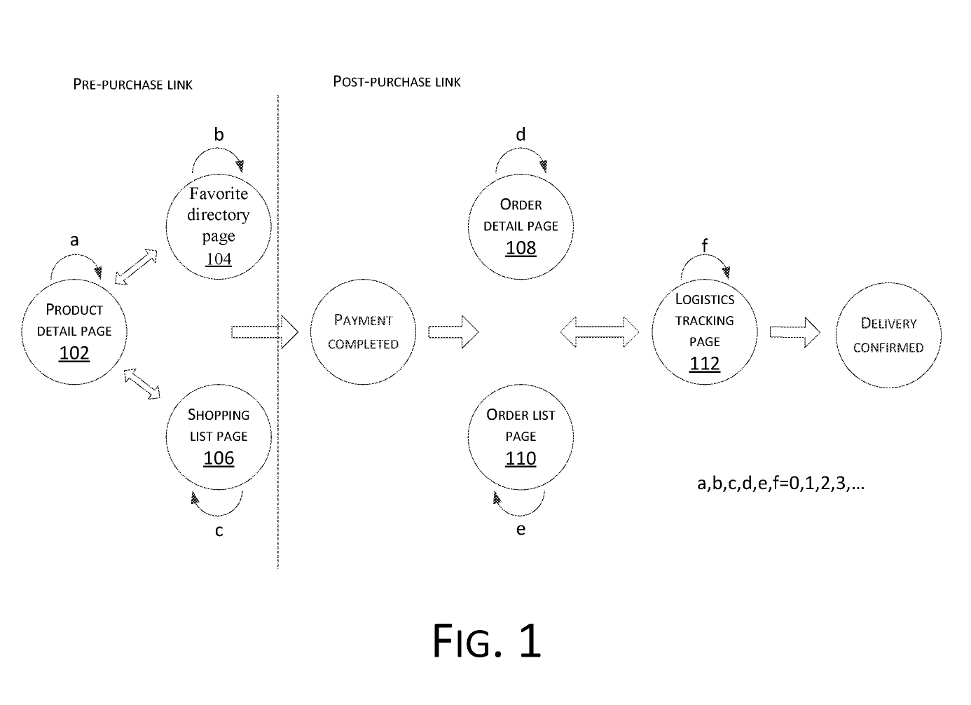

FIG. 1 illustrates a flowchart of example behavior sequence of a user before and after a product transaction. Referring to FIG. 1, in an actual situation, after a user is interested in a product A, the user will frequently visit a product detail page 102 of the product A. Afterwards the user may store the product A into a favorite directory page 104. Subsequently the user may visit the favorite directory page 104 or a shopping list page 106 to visit the product detail page of the product A. After multiple cycles of operations, the user decides to purchase the product A and completes the payment. After payment of the product A, the user may visit an order detail page 108 of the product A multiple time to determine whether the merchant has shipping the product, or inquire the order detail of the product A at an order list page 110 to confirm whether there is logistics information. After the generation of the logistic information of the product A is confirmed, the user may visit a logistics tracking page 112 multiple time to check the logistic status of the product A until the product A is delivered to the user. The user confirms delivery after checking that the product A has no quality problem. FIG. 1 shows a number of times that the use visits the product detail page, a saved product list page, and a shopping list page, which are represented by a, b, c, d, e, and f respectively.

Based on the flowchart of the user behaviors as shown in FIG. 1, the purpose of the present disclosure is to recommend products that are more valuable and more conform to the user's intention before the product is purchased and to accelerate the user's decision for making order, and to advise more strategies to the user after the product is purchased through reasonable and intelligent recommendation.

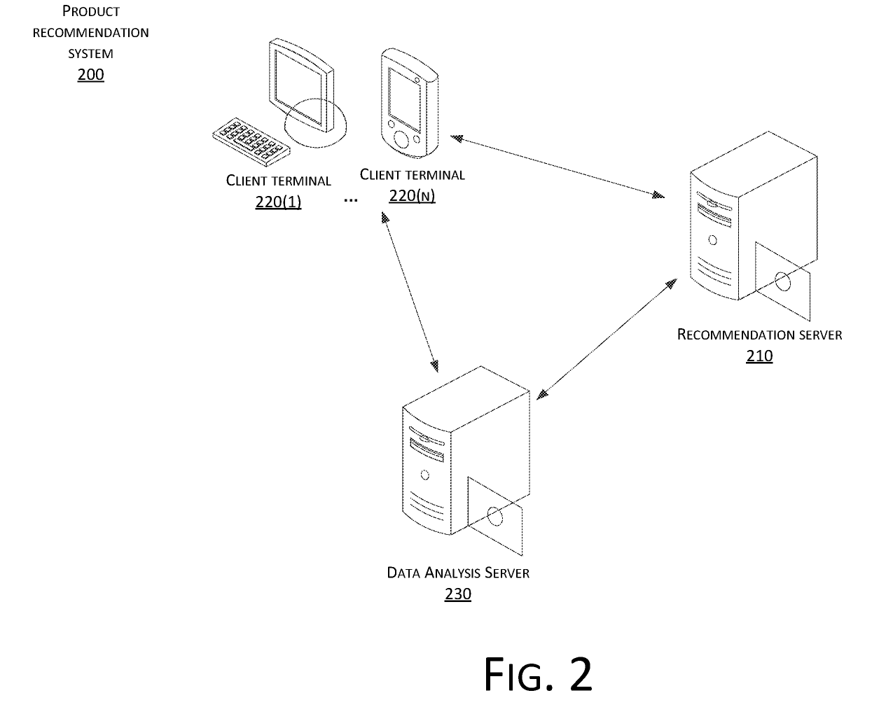

Based on the above technical environment, the present disclosure also provides an intelligent recommendation system. FIG. 2 illustrates an example product recommendation system 200 for intelligent recommendation. The product in the present disclosure includes, but is not limited to, any type of the product that is available on the market for the user to consume or use. In some example embodiments, the product may be a tangible product such as cloth, coffee, car. In some other example embodiments, the product may be intangible product such as service, education, game, or virtual resource. The product recommendation system 200 recommends to the user the product that more conforms to the user's preferences and intention based on the historical operation behavior data of the user.

For example, as shown in FIG. 2, the product recommendation system 200 provided by the present disclosure may include a recommendation server 210 and one or more client terminals 220(l), . . . , 220(n), n may be any integer, and the recommendation server 210 is coupled with the client terminal 220. The recommendation server 210 may include one or more servers, or may be integrated in one server.

In some other example embodiments, the product recommendation system 200 may further be configured to intensively learn the historical operation behavior data of the user, to realize a more intelligent user behavior link optimization modeling. Accordingly, as shown in FIG. 2, the system 200 may further include a data analysis server 230. The data analysis server 230 may be coupled with the recommendation server 210 and the client terminal 220 respectively. Similarly, the data analysis server 230 may include one or more servers, respectively, or may be integrated in one server.

Compared with the strategy that focuses on individual recommendation based on each distinct webpage, the techniques of the present disclosure integrate data of user's operation behaviors before and after visiting the webpage and then provide recommendation.

The recommendation based on the user's operation behaviors before and after visiting a particular page is a continuous decision problem. The recommendation system needs to continually decide what to recommend to the user based on a series of behaviors of the user (e.g., products, stores, brands and events). Reinforcing learning is an example method to model intelligent decision-making. In a nutshell, intensive learning recursively models the changes in the short-term state of smart decision maker, ultimately progressively optimize their long-term goals.

For example, a state of an intelligent decision maker (such as a recommendation system) is defined as the information that the recommendation system gathers prior to recommending to the user. For instance, the state includes the user's attribute information (such as gender, age, city and purchasing power) and the user's operation behavior sequence at the client terminal prior to the recommendation.

For example, an action of the intelligent decision maker is the content recommended to the user. The recommendation system, through the influences on the user based on the recommended content to the user, leads the following changes of states of the user.

For example, the reward that the recommendation system obtains from the change of the states (such as jumping from one page to another page) is based on the optimization goal. For instance, if the optimization goal is that the user purchases the recommended product, a positive reward is assigned to the recommendation system when the user makes purchases at the order page. For instance, the reward value may be the transaction amount of the purchased product. As the frequency of purchase is not high, in another example, a positive reward is assigned to the recommendation system when the user clicks the recommended content provided by the recommendation system. The techniques of the present disclosure also assign accumulative reward to the recommendation system to accumulate reward values within a preset time interval. A time efficient may be assigned to the reward values to make the recent reward values more valuable than future reward values.

The data analysis server 230 and the recommendation server 210 may be separate computing device or integrated into one computing device.

In some example embodiments, the client terminal 220 may be a mobile smart phone, a computer (including a laptop computer, a desktop computer), a tablet electronic device, a personal digital assistant (PDA) or a smart wearable device. In some other example embodiments, the client terminal 220 may also be software running on any of the above-listed devices, such as an Alipay client, a mobile Taobao client, a Tmall client, and the like. Certainly, the client terminal 220 may be a website with product recommendation functions.

The user may use different client terminals 220 to obtain the recommended products provided by the recommendation server 210 to complete one or more of the methods described in the technical solution below.

In order to express the use of reinforcement learning in product recommendation technology more clearly, the present disclosure firstly introduce the basic theoretical model of reinforcement learning, the Markov Decision Process (MDP). It would be apparent to those skilled in the art that various of reinforcement learning models may be applied to accomplish the spirit of the present disclosure.

The recommendation server 210, the client terminal 220, and the data analysis server 230 are computing devices, which may include one or more processors; and one or more memories storing thereon computer-readable instructions that, when executed by the one or more processors, cause the one or more processors to perform acts as described herein.

The memory is an example of computer readable media. The computer readable media include non-volatile and volatile media as well as movable and non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission media, and can be used to store information accessible to the computing device. According to the definition herein, the computer readable media do not include transitory media, such as modulated data signals and carriers.

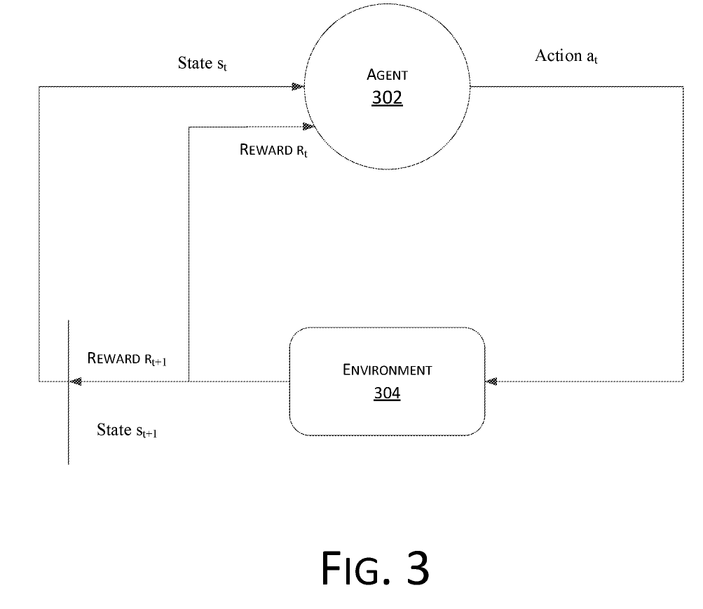

FIG. 3 is a schematic diagram of a model of an MDP provided by the present disclosure. As shown in FIG. 3, the MDP involves two entities, i.e., an agent 302 and an environment 304, that interact with each other. The Agent is an entity that makes decisions. The environment is an entity for information feedback. For example, in the application scenario of product recommendation technology, the Agent may be set as the main subject for making product recommendation decisions, and the environment may be set to feedback the user's behavior of clicking browsed products and purchasing products to the Agent. MDP may be represented by a four-tuple<S, A, R, T>, where,

(1) S is a State Space, which contain a set of environmental states that the Agent may perceive.

(2) A is an Action Space, which contain the set of actions the Agent may take on each state of the environment.

(3) R is a Rewarding Function, and R (s, a, s′) represents the reward that the Agent obtains from the environment when the action a is performed on the state s and the state is changed to state s′

(4) T is the State Transition Function, and T (s, a, s′) can represent the probability of executing action a on state s and moving to state s′.

As shown in FIG. 3, in the process of interaction between the Agent and the environment in the MDP, the Agent senses that the environment state at time t is sₜ. Based on the environment state sₜ, the Agent may select an action at from the action space A to execute. After the environment receives the action selected by Agent, it returns corresponding reward signal feedback rₜ₊₁ to the Agent and transfers to new environment state sₜ₊₁, and waits for Agent to make a new decision. In the process of interacting with the environment, the goal of Agent is to find an optimal strategy π* such that π* obtains the largest long-term cumulative reward in any state s and any time step t, where π* is defined in Formula 1):

$${π}^{*} = arg max {x}_{π} {E}_{π} \{ {\sum }_{k = 0}^{∞} {γ}^{k} {r}_{t + k} \vert {s}_{t} = s \} , ∀ s ∈ S , ∀ t \geq 0 \qquad ( 1 )$$

Where π denotes a particular strategy of the Agent (i.e., the probability distribution of the state to the action), E_{π}denotes the expected value under the strategy π, γ is the discount rate, k is the future time step, and rₜ₊ₖ denotes the Agent's instant reward on the time step (t+k).

Based on the above MDP model, the intelligent recommendation method provided by the present disclosure extracts each current link state of the user, and the recommendation server 210 outputs the corresponding recommendation behavior according to a certain recommendation strategy. Then the recommendation server 210 or the data analysis server 230 iteratively update the recommendation strategy by using the reinforcement learning method according to the user's feedback interaction data, to finally learn the optimal recommendation strategy step by step.

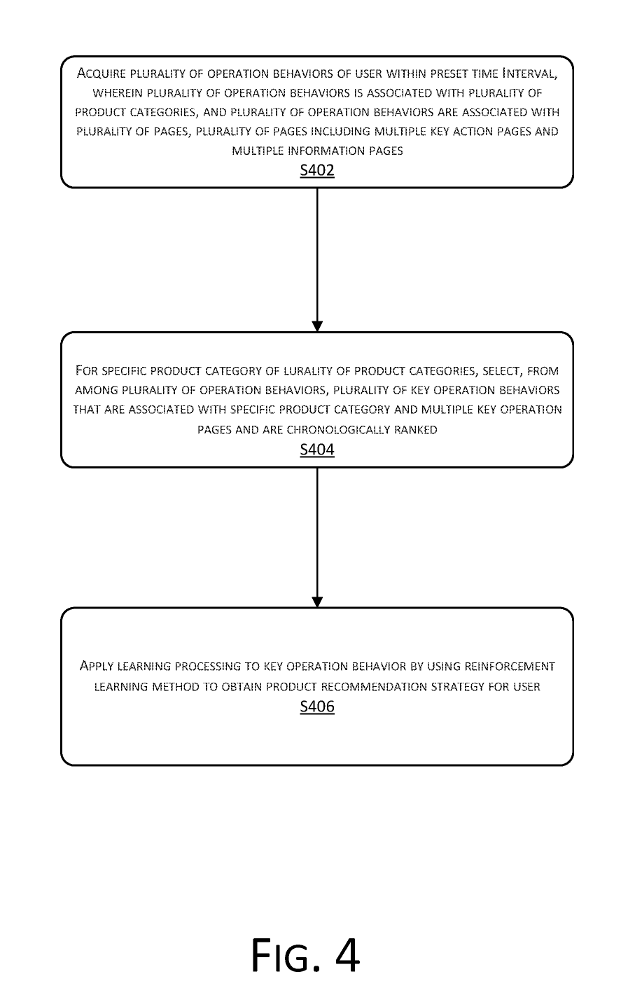

The intelligent recommendation method described in the present disclosure is described in detail below with reference to the accompanying drawings. FIG. 4 is a schematic flowchart of an example method for intelligent recommendation method according to an example embodiment of the present disclosure. Although the present disclosure provides the operations or steps of the method as shown in the following examples or figures, more or less steps may be included in the method based on conventional or non-creative labor. In the steps that do not have the necessary causal relationship in logic, the execution order of these steps is not limited to the execution sequence provided by the example embodiment of the present disclosure. The method may be executed sequentially or in parallel (for example, a parallel processor or a multi-thread processing environment) according to the method shown in the example embodiments or the accompanying drawings during the actual intelligent recommendation process or execution by a device.

The recommendation server 210 may perform the method for intelligent recommendation as shown in FIG. 4. As shown in FIG. 4, the recommendation server 210 may include the following steps:

S402: A plurality of operation behaviors of a user within a preset time interval are acquired, wherein the plurality of operation behaviors is associated with a plurality of product categories, and the plurality of operation behaviors are associated with a plurality of pages, the plurality of pages including multiple key action pages and multiple information pages.

In combination with the above MDP model, the recommendation server 210 corresponds to the Agent, and the current link state of the user corresponds to the state s. The Agent determines the current state s, and according to a certain strategy, outputs the corresponding action a. Correspondingly, the recommendation server 210 may provide the recommended behavior according to a certain recommendation strategy and the current link status of the user. In this example embodiment, the link status may include a plurality of key operation behaviors of the user within a preset time interval that are ranked based on time sequence.

Generally, the shopping APP includes multiple pages. Each page corresponds to a specific scene, such as a product detail page, a favorite directory page, a shopping list page, a payment page, an information announcement page, an order detail page, an order list page and so on. In one example embodiment, the plurality of pages may include a plurality of key operation pages and a plurality of information pages. The key operation pages may include a page that has a greater impact on the user's default decision behavior during the product transaction period. The information page may include a page that displays notice, rule information in a shopping App. For example, the key operation page may include a product details page, a favorite directory page, a shopping list page, a payment page, an order details page, an order list page, and the like. The information page may include a transaction rule introduction page, an announcement page, and the like.

In an example embodiment, the key operation page may include a page with an influence factor greater than a preset threshold on the preset user behavior. The influence factor may include a value of influence on a preset user behavior, and the preset user behavior may include a user transaction decision.

Since the page corresponds to the scene, and the user may perform various actions in the scene, the user may also perform various operations at the page. For example, at the product detail page, the user may save, add, purchase, and share the corresponding product. At the product List page, the user may save and browse for any product in the list. As shown in FIG. 2, the recommendation server 210 and the client terminal 220 are coupled to each other to acquire the operation behaviors records of the plurality of pages user stored in the client terminal 220.

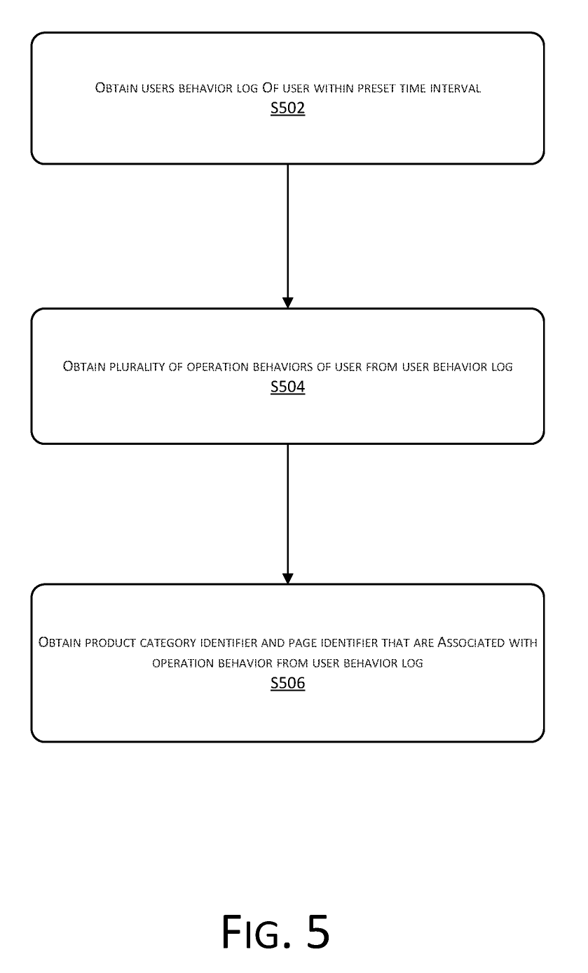

In an example embodiment of the present disclosure, as shown in FIG. 5, the acquiring multiple operation behaviors of the user within a preset time interval may include:

S502: obtaining a user behavior log of a user within the preset time interval;

S504: obtaining a plurality of operation behaviors of the user from the user behavior log; and

S506: obtaining, from the user log, a product category identifier and a page identifier that are associated with the operation behavior.

In this example embodiment, the user behavior log of the user within the preset time interval may be acquired, where the user behavior log may record an operation behavior record of the user within the preset time interval. In the user behavior log, the action record is associated with the operation time, the product category identifier, the page identifier and other information.

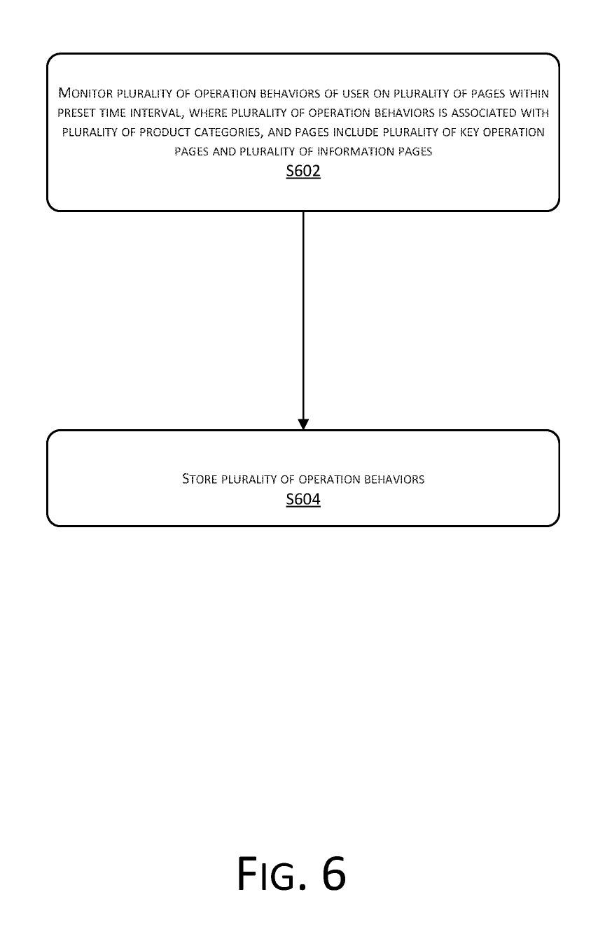

In another example embodiment, as shown in FIG. 6, the acquiring multiple operation behaviors of the user within the preset time interval may further include:

S602: monitoring a plurality of operation behaviors of a user on a plurality of pages within a preset time interval, where the plurality of operation behaviors is associated with a plurality of product categories, and the pages include a plurality of key operation pages and a plurality of information pages; and

S604: storing the plurality of operation behaviors.

In this example embodiment, the multiple operation behaviors may also be acquired in another manner. For example, multiple operation behaviors on the multiple pages may be monitored, and at the same time, the multiple operation behaviors are stored.

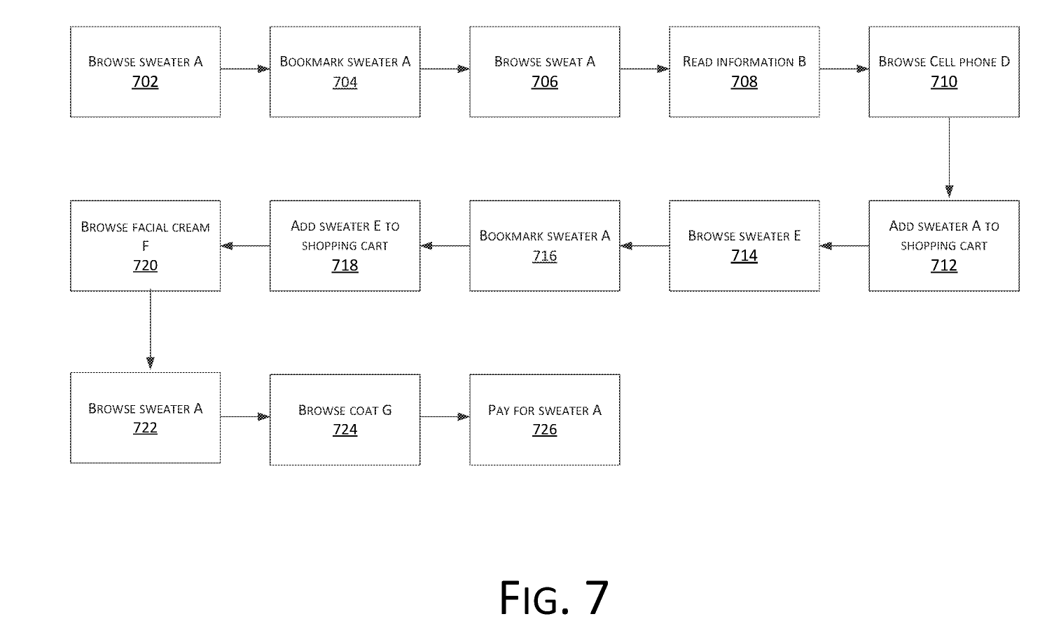

The method is described below by using a specific example of a scenario. FIG. 7 is a list of 13 operation behaviors of the user acquired from the user behavior log in chronological order within 15 minutes from the reference time. The 13 operation behaviors are browse sweater A 702, bookmark sweater A 704, browse sweater A 706, read information B 708, browse cell phones D 710, add sweater A to shopping cart 712, browse sweater E 714, bookmark sweater A 716, add sweater A to shopping cart 718, browse facial cream F 720, browse sweater A 722, browse coat G 724, and pay for sweater A 726. The above 13 operation behaviors are associated with multiple product categories. If the analysis is performed only on a first-level product category, it related to three categories: clothing (sweater A, sweater E, jacket G), cell phone (cell phone D), cosmetics (cream F). In addition, the above 13 operation behaviors are associated with multiple pages, where the key operation page includes pages associated with operation behaviors 702-706 and 710-726. Operational behavior 708 “Read Information B” generally does not play an important role in the user's transaction decision-making process. Therefore, the page associated with operation behavior 708 is the information page.

It should be noted that, the preset time interval in this example embodiment may be set according to the implementation frequency of the operation behavior of the user, and specifically may include any numerical time interval, which is not limited herein. The product category in this example embodiment may be a first-level category or any category below the first level, which is not limited herein. The setting of the key operation page is not limited to the above example, and may include any page whose impact factor on the preset user behavior is greater than a preset threshold, which is not limited herein.

S404: For a specific product category of the plurality of product categories, from among the plurality of operation behaviors, a plurality of key operation behaviors that are associated with the specific product category and the multiple key operation pages and are chronologically ranked are selected.

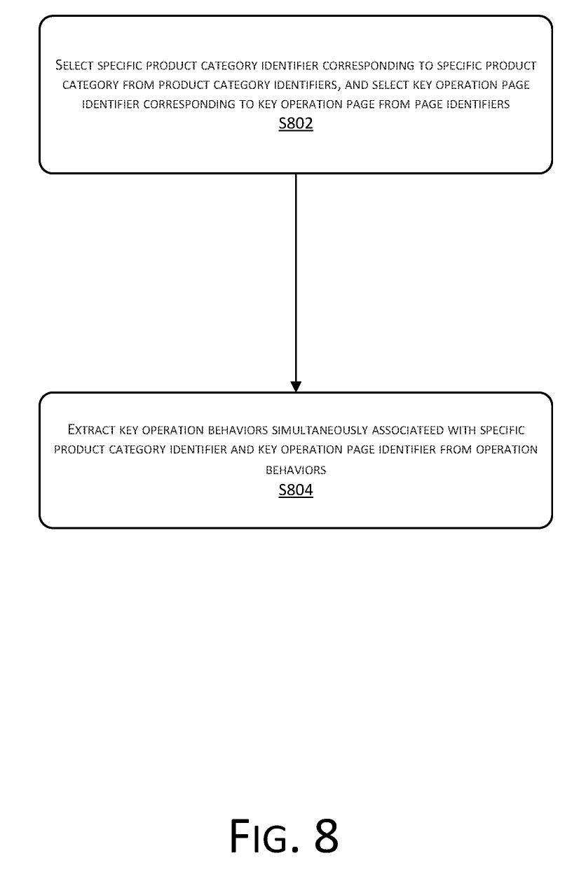

In an example embodiment of the present disclosure, the plurality of key operation pages may be selected through a product category identifier and a key operation page identifier. For example, the product category identifier may include a product category ID. The key operation page identifier may include, for example, a key operation page ID and so on. As shown in FIG. 8, the S404 may include the following operations:

S802: a specific product category identifier corresponding to a specific product category is selected from the product category identifiers, and a key operation page identifier corresponding to the key operation page is selected from the page identifiers.

S804: a plurality of key operation behaviors that are simultaneously associated with the specific product category identifier and the key operation page identifier are extracted from the multiple operation behaviors.

In another example embodiment of the present disclosure, a plurality of preliminary operation behaviors associated with a specific product category may be screened out from the plurality of operation behaviors and then the multiple key operational behaviors associated with the key operations page are selected from the plurality of preliminary operation behaviors,

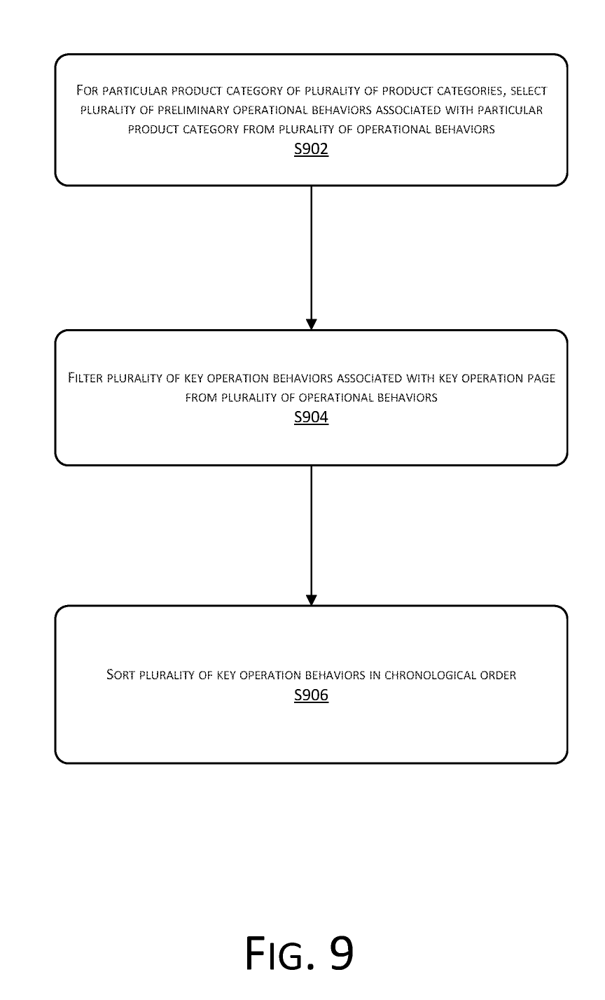

As shown in FIG. 9, the S404 may include the following operations:

S902: for the particular product category of the plurality of product categories, a plurality of preliminary operational behaviors associated with the particular product category are selected from the plurality of operational behaviors;

S904: a plurality of key operation behaviors associated with the key operation page are filtered from the plurality of operational behaviors; and

S906: the plurality of key operation behaviors is sorted in chronological order.

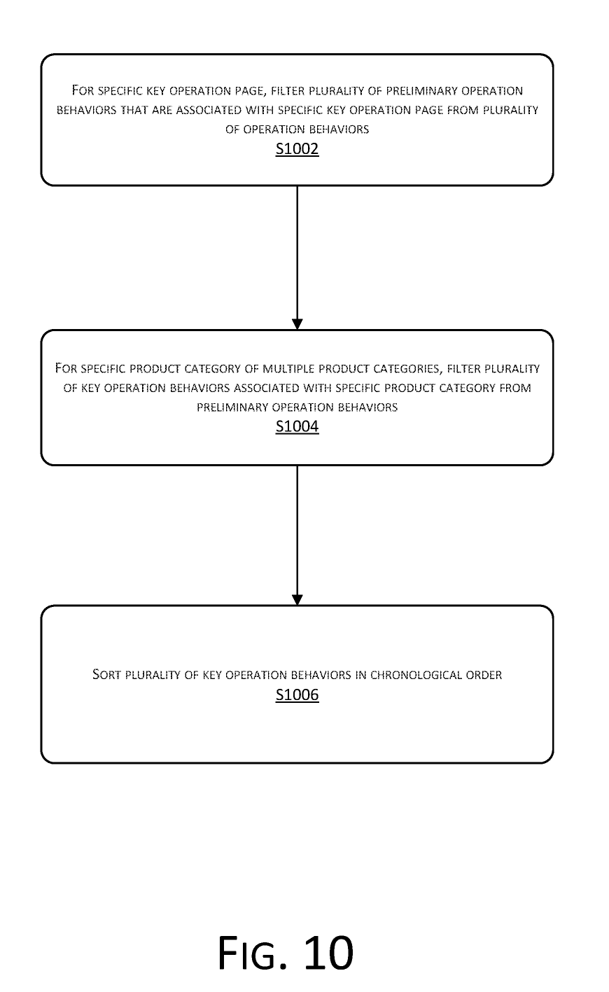

In another example embodiment of the present disclosure, a plurality of preliminary operation behaviors associated with the key operation page may be firstly screened out from the plurality of operation behaviors and then the plurality of preliminary operation behaviors associated with the particular product category are screened out from the plurality of preliminary operation behaviors. As shown in FIG. 10, the S404 may include:

S1002: for a specific key operation page, a plurality of preliminary operation behaviors that are associated with the specific key operation page are filtered from the plurality of operation behaviors;

S1004: for the specific product category of the multiple product categories, a plurality of key operation behaviors associated with the specific product category are filtered from the preliminary operation behaviors; and

S1006: the plurality of key operation behaviors is arranged in chronological order.

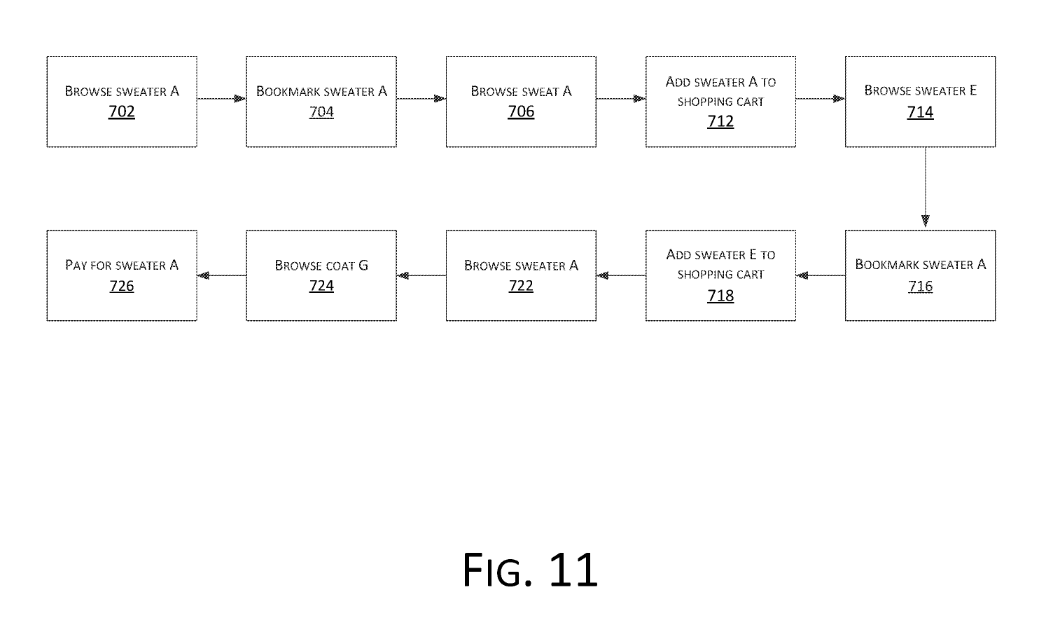

In this example embodiment, the specific product category may include any one product category associated with the plurality of operational behaviors. For example, in the operation behavior link of the user shown in FIG. 7, three product categories are involved, namely clothing, mobile phone and cosmetics. Wherein the operational behaviors associated with the garment category include operational behaviors at 702-706, 712-718, 722-726, operational behaviors associated with the cellular phone category include operational behavior at 710, and operational behaviors associated with the cosmetic category include operational behavior at 720. The operation behavior associated with the key operation page includes the operation behavior at 702-706, 710-726, and the operation behavior associated with the information page includes the operation behavior 708. In this example embodiment, the time-based key operation behaviors related to the clothing category and the key operation page may be selected. Therefore, the techniques of the present disclosure exclude the operation behavior 710 associated with the cell phone category, the operation behavior 720 associated with the cosmetics category, the operation behavior 708 associated with the information page, and sort the remaining operation behaviors at 702-706, 712-718, 722-726 in a chronological order to generate the operation behavior chain as shown in FIG. 11.

In this example embodiment, a plurality of operation behaviors of the user within a preset time interval are filtered according to a reference standard such as a product category and a page feature, denoised, and a sequence of key operation behaviors based on a time sequence is generated. Since the sequence of key operation behaviors is based on a specific product category and a key operation page, the sequence of key operation behaviors may more clearly express a preference and an intention of a user for a specific product category within a preset time interval.

S406: Learning processing is applied to the key operation behavior by using a reinforcement learning method to obtain a product recommendation strategy for the user.

After the user's operation behaviors that are out of order and complicated in the preset time interval are processed into a plurality of clear and explicit key operation behaviors, the reinforcement learning method is applied to the key operation behaviors for learning processing to obtain a product recommended strategy for the user.

The product recommendation strategy in this example embodiment may include selecting a preset number of recommended products from a limited collection of products. As described above, the MDP includes the state space S and the action space D, wherein the plurality of key operation behaviors corresponds to the state space S, and the limited product set corresponds to the action space D. In the intelligent recommendation method provided by the example embodiment of the present disclosure, both the state space S and the action space D are limited large-scale spaces.

As mentioned above, in reinforcement learning, in the process of interacting with environment, the goal of Agent (i.e., the recommendation server 210) is to find an optimal strategy π* such that π* receives the biggest long-term cumulative reward in any state s and any time step t. In some example embodiments, the above objective may be achieved using a value function approximation algorithm. In other example embodiments, the foregoing objectives may also be implemented by using other reinforcement learning algorithms such as a strategy approximation algorithm, which is not limited herein.

In addition, the recommendation server 210 may implement the learning optimization process. For example, the process may be processed by the data analysis server 230 separately, and the data analysis server 230 may perform reinforcement learning synchronously or asynchronously with the recommendation server 210 in the background.

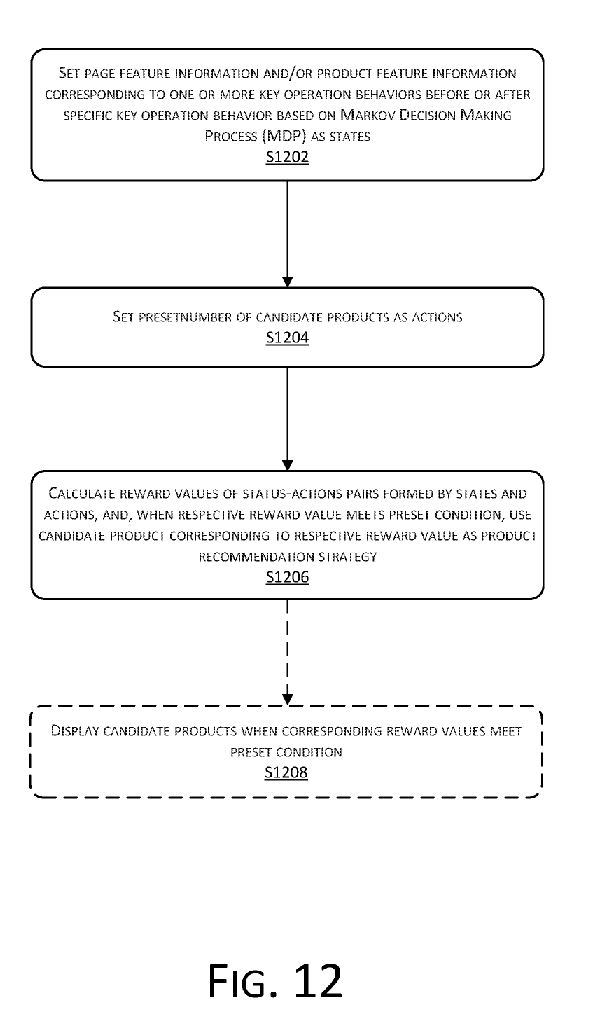

In an example embodiment of the present disclosure, as shown in FIG. 12, the reinforcement learning method is applied to the key operation behavior for learning processing to obtain a product recommendation strategy for the user, which may include:

S1202: page feature information and/or product feature information corresponding to one or more key operation behaviors before or after a specific key operation behavior based on a Markov Decision Making Process (MDP) is set as the states.

S1204: a preset number of candidate products is set as actions;

S1206: the reward values corresponding to the state-action pairs formed by the states and the actions are calculated, and when a respective reward value meets the preset condition, use the candidate product corresponding to the respective reward value as the product recommendation strategy.

Since the state space (multiple key operation behaviors) and the action space (limited product collection) in the present disclosure are both limited and large-scale spaces, the Q function approximation algorithm may be used to obtain the optimal recommendation strategy in this example embodiment.

A specific scenario is given below to illustrate how the present disclosure combines S1202-S1206 with the Q-function approximation algorithm to obtain a method that calculates the optimal motion strategy in any state.

At first, the state in the reinforcement learning is defined.

At S406, a sequence of behaviors formed by a plurality of key operation behaviors is obtained. In the sequence of behaviors, each of the key operation behaviors may correspond to a state s. The information contained in state s has diversity and highly complexity. It is one of the problems to be solved by the present disclosure how to extract key information from diverse and complex information to reasonably express state s.

In this example embodiment, the page feature information and/or product feature information associated with one or more key operation behaviors preceding the key operation behavior may be taken as the state s. For example, the page characteristic information may include a page identifier, and the page identifier may include Boolean identification information of whether the page is a pre-purchase scenario or a post-purchase scenario. The product characteristic information may include the price, the sales volume, the listing time, the grade, the favorable rating, the purchase rate, the conversion rate, and the related characteristic information of the store dimension corresponding to the product. For example, in the operation behavior link shown in FIG. 11, the ten key operation behaviors for the clothing category are contained, and correspond to 10 states respectively. To express the state s corresponding to “browsing sweater E” of the key operation behavior 5, according to the definition of the above state s, the page corresponding to the previous key operation behavior 4, “adding sweater A”, preceding the key operation 5 is the list page. According to the schematic diagram of the pre-purchase and post-purchase links shown in FIG. 1, the shopping list page is in the pre-purchase link, and the Boolean identification information corresponding to the pre-purchase link is obtained. The product corresponding to the key operation behavior 4 is sweater A. The key operation behavior 4 obtains the price, sales, sales volume, listing, whether shipping fee is included, grade level, favorable rate, purchase rate, conversion rate, and the relevant feature information of the shop dimension where the sweater A is located. At this point, the state s corresponding to the key operation behavior 5 is obtained.

Further, since the user's age range, purchasing power, gender, and personality are closely related to the user's preference and intention. The user's personal attributes may be reflected in the state s. Specifically, the user's personality characteristic data may be added in the state s. For example, the personality characteristic data may include the user's stable long-term characteristic. For example, the personality characteristic data may include characteristic data such as the user's gender, age, purchasing power, product preferences, store preferences and the like. For example, the characteristic data corresponding to user A is {male, 26, purchasing power, hobby riding equipment, . . . }.

Second, the action in the reinforcement learning is defined.

In MDP, Agent carries out action a under the state s according to certain strategy. Since the product recommendation is different from the product search, the product search needs to display a large number of matched products to the user while the product recommendation only needs to display a small number of products to the user, such as, 12, 9, 16 and so on. In this example embodiment, the action a is the preset quantity of product information that needs to be displayed.

It should be noted that, the action space A corresponding to the action a is not all products in the shopping platform. In order to further reduce the dimension of the action space and improve the processing efficiency, the action space corresponding to the action a is set as a limited candidate product space. The candidate product space may be obtained through a method such as a behavior coordination recall method, a user preference matching method, and the like, which is not limited herein. In an example embodiment of the present disclosure, the candidate product includes a product set of the key operation pages to which the key operation behaviors correspond, and the products in the product set are associated with the key operation page. For example, assuming that each page corresponds to one product pool, and the product pool may include a plurality of products of the same category, the candidate product space may include the product pool of the page corresponding to the key operation behavior. Then, the action a includes recommending a preset quantity of products from the product pool through an optimal strategy to the user.

After the states and actions in the reinforcement learning are defined, the method for calculating the accumulated reward value that is obtained in any state s is constructed. In an example embodiment, the cumulative reward value calculation method may be represented by the following state value function formula (1)

V^{π}(s)=E_{π}[r(s′|s,a)+γV^{π}(s′)|s₀=s] (1)

V^{π}(s) represents the state value function for state s, E₉₀ represents the expected value of the cumulative reward obtained by Agent under strategy π, s′ represents the next state reached after executing action a in state s, r(s′|s,a) represents the instant reward for performing action a in state s, and γ∈|0,1] represents the reward discount rate.

Since both the state space and the motion space in the present disclosure are a finite space, a Q-function based on the state-motion pair is constructed based on the above-described state value function expression (1) as a cumulative reward that the state-motion pair obtains. Specifically, in one example embodiment, the accumulated reward that is acquired by any state-action pair may include:

Q^{π}(s, a)=E_{π}[r(s′|s, a)+γV^{π}(s′)|s₀=s,a₀=a] (2)

Q^{π}(s,a) represents the cumulative long-term reward obtained by the state-action to s-a under strategy π, that is, the cumulative value of reward generated in the subsequent learning optimization when Agent executes action a in state s.

Assuming that the state value function corresponding to the optimal strategy π* is V*(s) and the state-action value function corresponding to the optimal strategy π* is Q*(s,a), then V*(s) [symbol] Q*(s,a) has the following relationship:

V*(s)=maxₐQ*(s, a) (3)

In this example embodiment, the optimal learning strategy π* is learned by looking for the optimal state value function or action value function through the reinforcement learning method. In this example embodiment, the Q function about state s and action a is constructed based on the above formula (2):

Q(s, a; w)=f_{w}(ϕ(s),ψ(a))≈Q*(s, a) (4)

f represents the regression model, which includes linear regression, tree regression, neural network and other means;

ϕ(s) is the eigenvector of the state s, and as described above, the eigenvector ϕ(s) of the state s may contain two dimensions of feature information <u, context>, where:

u represents the personality characteristic data of the user and may include characteristic information such as the user's gender, age, purchasing power, category preference, shop preference, brand preference and the like;

context represents page feature information and/or product feature information associated with the previous key operation behavior preceding the current key operation behavior. The page feature information may include a page identifier. The page identifier may include Boolean identification information that indicates whether the page is a pre-purchase scenario or a post-purchase scenario. The product feature information may include price, sales volume, existence time, grade, favorable rate, purchase rate, conversion rate and related feature information of the store dimension corresponding to the product;

ψ(a) is the eigenvector of the product dimension in the action space, including product price, sales volume, shelves time, whether mail is included, grade, favorable rate, purchase rate, conversion rate, and the characteristic information of the store corresponding to the product, (such as the store's comprehensive score, return rate, etc.);

The parameter w represents the weight vector of the eigenvectors ϕ(s) and ψ(a), and are used to represent the weight value corresponding to the characteristic parameter in the eigenvector.

In this example embodiment, the Q function (4) is approximated to the optimal Q value by updating the parameter w. The update formula of the Q function may include:

Q(Sₜ, Aₜ)←Q(Sₜ, Aₜ)+α(Rₜ₊₁+γmaxₐQ(Sₜ₊₁,a)−Q(Sₜ, Aₜ)) (5)

Where Q(Sₜ,Aₜ) represents the estimated cumulative reward obtained by executing the action Aₜ in the state Sₜ; Rₜ₊₁ represents the instant reward value obtained in the next state Sₜ₊₁ after executing the action Aₜ in the state Sₜ; maxₐQ(Sₜ₊₁,a) represents the estimated optimal value that is obtained under state Sₜ₊₁; α∈(0,1] represents the influence of estimation error, similar to stochastic gradient descent, and finally converges to the optimal Q value. When Sₜ₊₁ is the final state, the algorithm stops the evaluation iteration. In this example embodiment, the final state is defined as the final desired state, such as the product transaction (as shown in FIG. 1, the product delivery step), and the valuation for all final states is directly set as the instant reward value r, such as the final transaction amount. For example, the instant reward function may include:

$$r = \{ \begin{matrix}0 , no click \\ c , click \\ transaction amount , transaction\end{matrix} \qquad ( 6 )$$

If the user clicks on the product, the obtained instant reward is a constant c, and if the user makes the transaction, the obtained instant reward is the transaction amount of the product.

According to the definition of formulas (5) and (6), the Q-Learning valuation iteration is performed using the key operation behavior sequence shown in FIG. 11 as sample data. In particular, the Q value for each of the key operation behaviors in FIG. 11 may be updated. For example, the state definitions corresponding to the ten key operation behaviors shown in FIG. 11 are denoted as S₁-S₁₀, and the updated Q values corresponding to each state are Q₁-Q₁₀The status S₁₀ corresponding to the key operation behavior 10 “Pay Sweater A” is taken as the final status. Then, the instant reward obtained in the status S₁₀ is the transaction amount of the sweater A, such as 100. With respect to the key operation behavior 9 “Browse Coat G”, according to formula 5 (assuming that α is 1, the discount rate γ is 0.9, and c is 1), Q₉ is R₁₀+0.9 maxₐQ(S₁₀,a) according to formula 5. Since the optimal evaluation value obtained at S₁₀ is 100, the instant reward of transitioning to the state S10 after performing a certain action in the state S9 is R₁₀=c=1, and the updated Q9 is calculated as 91. By analogy, the updated Q values of Q₁-Q₁₀ corresponding to states S₁-S₁₀ are calculated.

When the updated Q values Q₁-Q₁₀ corresponding to the states S₁-S₁₀ are calculated, the Q values Q₁-Q₁₀ may be regressed and fitted by using the regression model f in the formula (4) to obtain the updated w parameter values. At this point, an optimization of the Q function in formula (4) is completed. The parameter w represents the weight vectors of the eigenvectors ϕ(s) and ψ(a), the eigenvectors ϕ(s) and ψ(a) represent the features of the state s and the features of the action a, respectively. According to the above definition of state s and action a, the state s may include page feature information and/or product feature information, user personality feature information and the like, and action a may include a feature vector of the product dimension in the action space (candidate product space). Then according to the optimization of the parameter w, the weight value corresponding to each characteristic parameter in the state s and the action a is more in line with the user's preference and intention. In a specific scenario, according to the feature information of the product associated with the key operation behavior of user A, the techniques of the present disclosure find that user A prefers a product with a higher rating rate than other product feature parameters. Then, after an optimization of w parameters, the favorable rate corresponding to the weight value will be increased. However, sometimes the user's intentions are not clear. In the last scenario, user A may prefer a product with higher rating, and then user A may prefer a higher-selling and more expensive product in the next scenario. Then, In the method of this example embodiment, the w parameter is optimized to increase the weight values corresponding to the sales volume and the price of the product. Thus, irrespective of whether the purchase purpose of the user is clear or not, the parameter value of the w parameter is always closely related to the user's intention and preference through the optimization manner in this example embodiment.

After the Q function is optimized, the state s (such as the page feature information and/or the product feature information) are input to the optimized Q function to obtain the optimal product recommendation strategy a. After determining the parameter value of parameter w, the Q value corresponding to each action in the action space (such as the candidate product space) is calculated according to formula (4), and the action with Q value in the action space satisfies the preset condition is taken as the optimal product recommendation strategy a. The preset condition may include an action with Q value greater than a preset threshold or a preset number of actions with top Q value. For example, the action space is a product pool of a page corresponding to the key operation behavior, and the product pool includes 500 candidate products. The Q function estimation value of each candidate product in the product pool is calculated through a Q function approximation method. The Q function estimates are arranged in descending order and the nine candidate products with the highest Q function estimation are presented as recommended products according to the method steps shown in S1208, which displays candidate products when corresponding reward values meet the preset condition.

Using the Q function optimization method, the finite large-scale state action space is transformed into a parameter space, and the generalization of the Q function is increased while the dimension is reduced. The method of the present example embodiment may express the high-dimensional vectors ϕ(s) and ψ(a) using any state s where the user is and the action a that is executed in the state s. Then, just by choosing a way of function mapping, the high dimensional vectors ϕ(s) and ψ(a) are mapped to the scalar to fit the objective function Q*(s,a). In this way, the super-large-scale state-motion space is transformed into the high-dimensional vector space, and the unified parameter expression based on the high-dimensional vector space is obtained. With respect to the unknown future states and actions in the future, estimates of the value function are applied to achieve the purpose of generalization.

Then, in the product recommendation, the Q function is fit and learned by using the key operation behavior sequence, and the parameter w in the Q function is gradually optimized so that the parameter w value is gradually optimized according to the change of the user's preference and intention until convergence is stable. The optimized Q function is used to calculate the Q-function estimate of each product in the candidate product space. The larger the Q-function estimate is, the higher the recommended value of the product is. The Q-function optimization method may gradually learn large-scale discrete operation behavior of users, which is reflected in that the w parameter of the Q function gradually converges. When the w parameter is converged, the user's discrete behavior is converted into the user's preference and intention. Based on the general characteristics of the user, more accurate product information is recommended to the user

It should be noted that the reinforcement learning method used in the present disclosure is not limited to the value function approximation algorithm (such as the Q function approximation algorithm described above), but may also include any reinforcement learning method that calculates the optimal action strategy in any state, such as a strategy approximation algorithm, which is not limited herein.

Correspondingly, the present disclosure further provides an intelligent recommendation system, which include a client terminal, a recommendation server, and a data analysis server.

The client terminal stores the user's operating behavior;

The recommendation server obtains a plurality of operation behaviors of the user within a preset time interval, wherein the plurality of operation behaviors is associated with a plurality of product categories, and the plurality of operation behaviors are associated with a plurality of pages. The plurality of pages includes a plurality of key operation pages and a plurality of information pages. The recommendation server further selects, with respect to the specific product category of the plurality of product categories, multiple key operation behaviors associated with a plurality of key operation pages from the plurality of operation behaviors and ranked based on time sequence.

The data analysis server performs learning processing on the key operation behaviors by using a reinforcement learning method to obtain a product recommendation strategy for the user.

Optionally, in an example embodiment of the present disclosure, the learning processing the key operation behavior by using the reinforcement learning method to obtain the product recommendation strategy for the user may include:

based on a Markov Decision Making Process (MDP), using, as a status, page feature information and/or product feature information corresponding to one or more key operation behaviors before the key operation behavior;

using a preset number of candidate products as actions;

calculating a reward value corresponding to the state action pair formed by the state and the motion, and using the candidate product corresponding to the reward value satisfying the preset condition as the product recommendation strategy.

Optionally, in an example embodiment of the present disclosure, the candidate product may include a product set of the key operation page to which the key operation behavior corresponds, and a product in the product set is associated with the key operation page.

Optionally, in an example embodiment of the present disclosure, the key operation page may include a page whose impact factor on the preset user behavior is greater than a preset threshold.

Optionally, in an example embodiment of the present disclosure, the acquiring multiple operation behaviors of the user within a preset time interval may include:

obtaining a user's user behavior log within a preset time interval;

obtaining, from the user behavior log, a plurality of operation behaviors of the user; and

obtaining, from the user log, a product category identifier and a page identifier that are associated with the operation behavior.

Optionally, in an example embodiment of the present disclosure, the acquiring multiple operation behaviors of the user within a preset time interval may include:

monitoring a plurality of operation behaviors of a user on a plurality of pages within a preset time interval, the plurality of operation behaviors being associated with a plurality of product categories, the plurality of pages including a plurality of key operation pages and a plurality of information pages; and

storing the plurality of operational behaviors.

Optionally, in an example embodiment of the present disclosure, the step of selecting, with respect to the specific product category of the plurality of product categories, multiple key operation behaviors associated with a plurality of key operation pages from the plurality of operation behaviors and ranked based on time sequence includes:

selecting, with respect to the specific product category of the plurality of product categories, multiple preliminary operation behavior associated with the specific product category from the plurality of operation behaviors; and

filtering multiple key operation behaviors associated with the key operation pages from the multiple preliminary operation behaviors; and

ranking the multiple key operation behaviors based on a time sequence.

Optionally, in an example embodiment of the present disclosure, the step of selecting, with respect to the specific product category of the plurality of product categories, multiple key operation behaviors associated with a plurality of key operation pages from the plurality of operation behaviors and ranked based on time sequence includes:

with respect to a key operation page, filtering multiple preliminary operation behaviors associated with the key operation page from the plurality of operation behaviors;

with respect to a particular product category of the plurality of product categories, filtering multiple key operational behaviors associated with the particular product category from the preliminary operation behaviors; and

ranking the multiple key operation behaviors based on a time sequence.

Optionally, in an example embodiment of the present disclosure, the status may further include personal attribute information of the user.

Optionally, in an example embodiment of the present disclosure, the client terminal may further display a candidate product corresponding to the reward value that meets a preset condition.

Optionally, in an example embodiment of the present disclosure, the reinforcement learning method may include a Q-function approximation algorithm.

The intelligent recommendation method and system provided by the present disclosure perform screening and denoising of a plurality of operation behaviors of users in a preset time interval according to product categories and page features to generate a sequence of key operation behaviors based on time sequence. Since the sequence of key operation behaviors is based on a specific product category and a key operation page, the sequence of key operation behaviors may more clearly express a preference and an intention of a user for a specific product category within a preset time interval. Therefore, the techniques of the present disclosure apply reinforcement learning of the key operation behavior sequence to learn more accurate user preferences, intentions, and other information, to improve the accuracy of product recommendation. In addition, the extraction and dimension reduction are applied to the multiple operational behaviors to further enhance the efficiency of reinforcement learning.

Although the present disclosure describes data learning and processing descriptions such as reinforcement learning method, learning processing, data sorting, and the like in the example embodiments, the present disclosure is not limited to those data presentation and display which are in full compliance with industry programming language design standards or those described in the example embodiments. Some embodiments based on a few revisions of the page design language or the description of the example embodiments herein may implement the same, equivalent, or similar, or predictable implement effects after modification of the above described example embodiments. Certainly, even if the above data processing or determination method are not used, as long as the techniques are in line with the data process or processing description of the present disclosure, the present disclosure are still implemented, which are not detailed herein.

Although the present disclosure provides the method operation or steps as described in the example embodiments or flow charts, more or fewer operations or steps may be included based on conventional or non-inventive means. The sequence of steps listed in the example embodiments is only one of many execution sequence, and does not represent the only execution sequence. When the actual device or client terminal product is executed, the processes shown in the example embodiments or the FIGS may be sequentially executed or executed in parallel (such as a parallel processor or a multi-thread processing environment).

Those skilled in the art will also appreciate that, in addition to implementing the controller in pure computer-readable instructions, it is entirely possible to logic program the method steps for the controller to be implemented in logic gates, switches, application specific integrated circuits, programmable logic controllers, and embedded microcontrollers and other forms to achieve the same function. Therefore, such a controller may be considered as a kind of hardware component, and an apparatus included therein for realizing various functions may also be regarded as a structure within a hardware component. Alternatively, the apparatus for implementing various functions may be considered as both a software module implementing the method and a structure within the hardware component.

This present disclosure may be described in the general context of computer-readable instructions executable by a computer, such as a program module. Generally, the program module includes routines, programs, objects, components, data structures, classes, etc. that perform particular tasks or implement particular abstract data types. The present disclosure may also be practiced in distributed computing environments where tasks are performed by remote processing devices that are connected through a communications network. In a distributed computing environment, program modules may reside in both local and remote computer storage media, including storage devices.

As shown from the description of the foregoing example embodiments, those of ordinary skill in the art may clearly understand that the present disclosure may be implemented by means of software plus a necessary universal hardware platform. Based on this understanding, the technical solutions of the present disclosure essentially, or the part contributing to the conventional techniques may be embodied in the form of a software product that is stored in a storage medium such as a ROM/RAM, a magnetic disk, an optical disc, or the like, including computer-readable instructions that cause a computer device (which may be a personal computer, a mobile terminal, a server, or a network device, etc.) to execute the method described in each example embodiment or part of the method.

The example embodiments in the present disclosure are described in a progressive manner, and the same or similar parts among the example embodiments may be referred to each other, and each example embodiment focuses on the differences from other embodiments. The present disclosure is applicable at many general purpose or special purpose computer system environments or configurations, such as personal computers, server computers, handheld devices or portable devices, tablet devices, multi-processor systems, microprocessor-based systems, set top boxes, programmable electronic devices, network PCs, minicomputers, mainframe computers, distributed computing environment including any of the above described system or device.

While the present disclosure is described through the example embodiments, those of ordinary skill in the art understand that there are any variations and changes of the present disclosure without departing from the spirit of the present disclosure. The appended claims are intended to include these modifications and variations without departing from the spirit of the present disclosure.

The present disclosure may further be understood with clauses as follows.

Clause 1: A system for intelligent recommendation, the system comprising: a client terminal that stores operating behaviors of a user: a recommendation server that obtain a plurality of operation behaviors of the user within a preset time interval, and further, with respect to a particular product category of a plurality of categories, selects multiple key operation behaviors from the plurality of operation behaviors, the plurality of operation behaviors being associated with the plurality of product categories, the plurality of operation behaviors being associated with a plurality of pages, the plurality of pages including a plurality of key operation pages and a plurality of information pages, the multiple key operation behaviors being ranked based on a time sequence; and a data analysis server that performs learning processing on the multiple key operation behaviors by using a reinforcement learning method to obtain a product recommendation strategy for the user.

Clause 2: The system of clause 1, wherein the performing learning processing on the multiple key operation behaviors by using the reinforcement learning method to obtain the product recommendation strategy for the user includes: based on a Markov Decision Making Process (MDP), using, as a status, page feature information and/or product feature information corresponding to one or more key operation behaviors before a key operation behavior of the multiple key operation behaviors; using a preset number of candidate products as an action; and calculating a reward value corresponding to a state action pair formed by the state and the motion, and adding a candidate product corresponding to a reward value satisfying a preset condition into the product recommendation strategy.

Clause 3: The system of clause 2, wherein the candidate product includes a product set of a key operation page corresponding to the key operation behavior, a product in the product set being associated with the key operation page.

Clause 4: The system of clause 1, wherein the key operation page includes a page with an influence factor on a preset user behavior greater than a preset threshold.

Clause 5: The system of clause 1, Wherein the obtaining the plurality of operation behaviors of the user within the preset time interval includes: obtaining a user behavior log of the user within the preset time interval; obtaining the plurality of operation behaviors of the user from the user behavior log; and obtaining product category identifiers and page identifiers that are associated with the plurality of operation behaviors from the user behavior log.

Clause 6: The system of clause 1, wherein the obtaining the plurality of operation behaviors of the user within the preset time interval includes: monitoring the plurality of operation behaviors of the user on the plurality of pages within the preset time interval, the plurality of operation behaviors being associated with the plurality of product categories, the page including the plurality of key operation pages and the plurality of information pages; and storing the plurality of operational behaviors.

Clause 7: The system of clause 5, wherein, with respect to the particular product category of the plurality of categories, selecting multiple key operation behaviors from the plurality of operation behaviors includes: selecting a particular product category identifier corresponding to the particular product category from the product category identifiers and a key operation page identifier corresponding to the key operation page from the page identifiers; and selecting the multiple key operation behaviors that are associated with the particular product category identifier and the key operation page identifier from the plurality of operation behaviors.

Clause 8: The system of clause 1, wherein, with respect to the particular product category of the plurality of categories, selecting multiple key operation behaviors from the plurality of operation behaviors includes: with respect to particular product category of the plurality of product categories, filtering multiple preliminary operation behaviors associated with the particular product category from the plurality of operational behaviors; filtering the multiple key operation behaviors associated with the multiple key operation pages from the multiple preliminary operation behaviors and ranking the multiple key operation behaviors based on the time sequence.

Clause 9: The system of clause 1, wherein, with respect to the particular product category of the plurality of categories, selecting multiple key operation behaviors from the plurality of operation behaviors includes: with respect to the key operation page, filtering multiple preliminary operation behaviors associated with the key operation page from the plurality of operational behaviors; with respect to the particular product category of the plurality of product categories, filtering the multiple key operation behaviors associated with the particular product category from the multiple preliminary operation behaviors and ranking the multiple key operation behaviors based on the time sequence.

Clause 10: The system of clause 2, wherein the status includes personal attribute information of the user.

Clause 11: The system of clause 2, wherein the client terminal displays the candidate product corresponding to the reward value satisfying the preset condition.

Clause 12: The system of clause 1 or 2, wherein the reinforcement learning method includes a Q-function approximation algorithm.

Clause 13: A method for intelligent recommendation, the method comprising: obtaining a plurality of operation behaviors of a user within a preset time interval, the plurality of operation behaviors being associated with a plurality of product categories, the plurality of operation behaviors being associated with a plurality of pages, the plurality of pages including a plurality of key operation pages and a plurality of information pages; with respect to a particular product category of the plurality of categories, selecting multiple key operation behaviors that are associated with the particular product category from the plurality of operation behaviors, the multiple key operation behaviors being ranked based on a time sequence; and performing learning processing on the multiple key operation behaviors by using a reinforcement learning method to obtain a product recommendation strategy for the user

Clause 14: The method of clause 13, wherein the performing learning processing on the multiple key operation behaviors by using the reinforcement learning method to obtain the product recommendation strategy for the user includes: based on a Markov Decision Making Process (MDP), using, as a status, page feature information and/or product feature information corresponding to one or more key operation behaviors before a key operation behavior of the multiple key operation behaviors; using a preset number of candidate products as an action; calculating a reward value corresponding to a state action pair formed by the state and the motion, and adding a candidate product corresponding to a reward value satisfying a preset condition into the product recommendation strategy.

Clause 15: The method of clause 14, wherein the candidate product includes a product set of a key operation page corresponding to the key operation behavior, a product in the product set being associated with the key operation page.

Clause 16: The method of clause 13, wherein the key operation page includes a page with an influence factor on a preset user behavior is greater than a preset threshold.

Clause 17: The method of clause 13, wherein the obtaining the plurality of operation behaviors of the user within the preset time interval includes: obtaining a user behavior log of the user within the preset time interval; obtaining the plurality of operation behaviors of the user from the user behavior log; and obtaining product category identifiers and page identifiers that are associated with the plurality of operation behaviors from the user behavior log.

Clause 18: The method of clause 13, wherein the obtaining the plurality of operation behaviors of the user within the preset time interval includes: monitoring the plurality of operation behaviors of the user on the plurality of pages within the preset time interval, the plurality of operation behaviors being associated with the plurality of product categories, the page including the plurality of key operation pages and the plurality of information pages; and storing the plurality of operational behaviors.

Clause 19: The method of clause 13, wherein, with respect to the particular product category of the plurality of categories, selecting multiple key operation behaviors from the plurality of operation behaviors includes: selecting a particular product category identifier corresponding to the particular product category from the product category identifiers and a key operation page identifier corresponding to the key operation page from the page identifiers; and selecting the multiple key operation behaviors that are associated with the particular product category identifier and the key operation page identifier from the plurality of operation behaviors.

Clause 20: The method of clause 13, wherein, with respect to the particular product category of the plurality of categories, selecting multiple key operation behaviors from the plurality of operation behaviors includes: with respect to particular product category of the plurality of product categories, filtering multiple preliminary operation behaviors associated with the particular product category from the plurality of operational behaviors; filtering the multiple key operation behaviors associated with the multiple key operation pages from the multiple preliminary operation behaviors and ranking the multiple key operation behaviors based on the time sequence.

Clause 21: The method of clause 13, wherein, with respect to the particular product category of the plurality of categories, selecting multiple key operation behaviors from the plurality of operation behaviors includes: with respect to the key operation page, filtering multiple preliminary operation behaviors associated with the key operation page from the plurality of operational behaviors; with respect to the particular product category of the plurality of product categories, filtering the multiple key operation behaviors associated with the particular product category from the multiple preliminary operation behaviors and ranking the multiple key operation behaviors based on the time sequence.

Clause 22: The method of clause 13, wherein the status includes personal attribute information of the user.

Clause 23: The method of clause 14, further comprising: displays the candidate product corresponding to the reward value satisfying the preset condition, after determining the candidate product corresponding to the reward value satisfying the preset condition as the product recommendation strategy.

Clause 24: The method clause 13 or 14, wherein the reinforcement learning method includes a Q-function approximation algorithm.

What is claimed is:

1. A server comprising:
one or more processors; and
one or more memories storing thereon computer-readable instructions that, when executed by the one or more processors, cause the one or more processors to perform acts comprising:
obtaining a plurality of operation behaviors of a user within a preset time interval, the plurality of operation behaviors being associated with a plurality of product categories and a plurality of pages, the plurality of pages including a plurality of key operation pages and a plurality of information pages; and
with respect to a particular product category of the plurality of categories, selecting multiple key operation behaviors from the plurality of operation behaviors, wherein the multiple key operation behaviors being ranked based on a time sequence.

2. The server of claim 1, wherein the acts further comprise:
performing learning processing on the multiple key operation behaviors by using a reinforcement learning method to obtain a product recommendation strategy for the user.

3. The server of claim 2, wherein the performing learning processing on the multiple key operation behaviors by using the reinforcement learning method to obtain the product recommendation strategy for the user includes:
setting, as states, page feature information and/or product feature information corresponding to one or more key operation behaviors before a key operation behavior of the multiple key operation behaviors;
setting a preset number of candidate products as actions;
calculating reward values corresponding to state-action pairs formed by the states and the actions; and
adding a candidate product corresponding to a reward value satisfying a preset condition into the product recommendation strategy.

4. The server of claim 3, wherein the candidate product includes a product set of a key operation page corresponding to the key operation behavior, a product in the product set being associated with the key operation page.

5. The server of claim 1, wherein the key operation page includes a page with an influence factor on a preset user behavior greater than a preset threshold.

6. The server of claim 1, wherein the obtaining the plurality of operation behaviors of the user within the preset time interval includes:
obtaining a user behavior log of the user within the preset time interval;
obtaining the plurality of operation behaviors of the user from the user behavior log; and
obtaining product category identifiers and page identifiers that are associated with the plurality of operation behaviors from the user behavior log.

7. The server of claim 1, wherein the obtaining the plurality of operation behaviors of the user within the preset time interval includes:
monitoring the plurality of operation behaviors of the user on the plurality of pages within the preset time interval, the plurality of operation behaviors being associated with the plurality of product categories, the plurality of pages including the plurality of key operation pages and the plurality of information pages; and
storing the plurality of operational behaviors.

8. The server of claim 6, wherein, with respect to the particular product category of the plurality of categories, selecting multiple key operation behaviors from the plurality of operation behaviors includes:
selecting a particular product category identifier corresponding to the particular product category from the product category identifiers and a key operation page identifier corresponding to the key operation page from the page identifiers; and
selecting, from the plurality of operation behaviors, the multiple key operation behaviors that are associated with both the particular product category identifier and the key operation page identifier.

9. The server of claim 6, wherein, with respect to the particular product category of the plurality of categories, selecting multiple key operation behaviors from the plurality of operation behaviors includes:
with respect to the particular product category of the plurality of product categories, filtering multiple preliminary operation behaviors associated with the particular product category from the plurality of operational behaviors;
filtering the multiple key operation behaviors associated with the multiple key operation pages from the multiple preliminary operation behaviors and
ranking the multiple key operation behaviors based a chronological order.

10. The server of claim 6, wherein, with respect to the particular product category of the plurality of categories, selecting multiple key operation behaviors from the plurality of operation behaviors includes:
with respect to a key operation page, filtering multiple preliminary operation behaviors associated with the key operation page from the plurality of operational behaviors;
with respect to the particular product category of the plurality of product categories, filtering the multiple key operation behaviors associated with the particular product category from the multiple preliminary operation behaviors and
ranking the multiple key operation behaviors based a chronological order.

11. The server of claim 1, further comprising displays candidate product corresponding to reward values satisfying a preset condition at a client terminal.

12. A method comprising:
obtaining a plurality of operation behaviors of a user within a preset time interval, the plurality of operation behaviors being associated with a plurality of product categories, the plurality of operation behaviors being associated with a plurality of pages, the plurality of pages including a plurality of key operation pages and a plurality of information pages;
with respect to a particular product category of the plurality of categories, selecting multiple key operation behaviors that are associated with the particular product category from the plurality of operation behaviors, the multiple key operation behaviors being ranked based on a time sequence; and
performing learning processing on the multiple key operation behaviors by using a reinforcement learning method to obtain a product recommendation strategy for the user.

13. The method of claim 12, wherein the performing learning processing on the multiple key operation behaviors by using the reinforcement learning method to obtain the product recommendation strategy for the user includes:
setting, as states, page feature information and/or product feature information corresponding to one or more key operation behaviors before a key operation behavior of the multiple key operation behaviors;
setting a preset number of candidate products as actions;
calculating reward values corresponding to state-action pairs formed by the states and the actions; and
adding a candidate product corresponding to a reward value satisfying a preset condition into the product recommendation strategy.

14. The method of claim 13, wherein the status includes personal attribute information of the user.

15. The method of claim 13, wherein the reinforcement learning method includes a Q-function approximation algorithm.

16. The method of claim 13, wherein the candidate product includes a product set of a key operation page corresponding to the key operation behavior, a product in the product set being associated with the key operation page.

17. The method of claim 16, wherein the key operation page includes a page with an influence factor for a preset user behavior inforgreater than a preset threshold.

18. The method of claim 12, wherein the obtaining the plurality of operation behaviors of the user within the preset time interval includes:
obtaining a user behavior log of the user within the preset time interval;
obtaining the plurality of operation behaviors of the user from the user behavior log; and
obtaining product category identifiers and page identifiers that are associated with the plurality of operation behaviors from the user behavior log.

19. The method of claim 12, further comprising displaying candidate product corresponding to reward values satisfying a preset condition at a client terminal.

20. One or more memories storing thereon computer-readable instructions that, when executed by the one or more processors, cause the one or more processors to perform acts comprising:
obtaining a plurality of operation behaviors of a user within a preset time interval, the plurality of operation behaviors being associated with a plurality of product categories, the plurality of operation behaviors being associated with a plurality of pages, the plurality of pages including a plurality of key operation pages and a plurality of information pages;
with respect to a particular product category of the plurality of categories, selecting multiple key operation behaviors that are associated with the particular product category from the plurality of operation behaviors, the multiple key operation behaviors being ranked based on a time sequence;
performing learning processing on the multiple key operation behaviors by using a reinforcement learning method to obtain a product recommendation strategy for the user.
